(19) United States
(12) Patent Application Publication
(10) Pub. No.: US 2014/0045144 A1
(43) Pub. Date: Feb. 13, 2014

(54) Dental Implant and Method of Implantation

(71) Applicant: Mazen Dukhan, Haddonfield, NJ (US)

(72) Inventor: Mazen Dukhan, Haddonfield, NJ (US)

(21) Appl. No.: 13/568,283

(22) Filed: Aug. 7, 2012

(51) Int. Cl. A61C 8/00

(52) U.S. Cl. 433/174

(57) ABSTRACT

A elf-tapping dental implant has a unitary body with an open end and a bottom tip end, The implant is tapered downward from the open top to the tip end and has an internal cavity extending for substantially the length of the implant. Smooth inner sidewalls are located at the upper end of the cavity and internal threads extend from the sidewalls down into the cavity. The method of utilizing the dental implant includes tapping the implant into the patient's mandible bone and utilizing a healing screw to heal. the patient's gum and an abatement member permanently locked into the implant to which the permanent crown is secured.

### FIELD OF THE INVENTION

The present invention relates to a dental implant and a method for surgically implantation of the dental implant, so as to support a prosthetic crown as a replacement for the tooth of a patient.

### BACKGROUND OF THE INVENTION

Prosthetic dental devices are very often necessary to replace natural teeth which are lost due to infection, disease, or some type of trauma. The dental endosteal or endosseous implant utilized for this practice is surgically implanted within the patient's mandibular or maxillary alveolar bone. After the gum and bone from the implantation process has healed, the implant is fitted with a tooth-simulating prosthesis or crown.

However, current implants and their methods of implantation have a number of limitations and disadvantages. For instance, most dental implant procedures require the installation of implants which protrude out of the gum and are thus exposed. This results both in prolonged discomfort for the patient and the possibility of implant malformation or failure during the initial healing process. Protruding devices also subject the effected area to infection or gum disease. Current methods also employ dental implants which often are unstable or which do not efficiently and/or effectively tap into the bone, thus creating additional problems for patient and dentist. Moreover, the use of known dental implants and implant techniques require excessive dental hardware, resulting in a more time consuming process and greater expense. Most significantly, the time period necessary to complete the dental implantation to finished crown procedure, including the allowance of an adequate healing period, is lengthy, usually at least six months.

### SUMMARY OF THE INVENTION

It is thus the object of the present invention to provide a dental implant and method of implantation which overcomes the disadvantages and limitations of prior implants and methods of their use.

It is an object of the present invention to provide a dental implant which is uniquely configured to be tapped into the bone of the patient efficiently and effectively with the least trauma to the patient during the procedure.

It is another object of the present invention to provide a dental implant which provides a high degree of initial implant stability during the implantation process.

It is a further object of the present invention to provide a dental implant which has a back tapered coronal design for maximum alveolar volume and improved soft tissue support.

It is still another object of the present invention to provide a dental implant which has an upper platform for greater soft tissue interface.

It is another object of the present invention to provide a dental implant which, in its method of implantation, is readily adaptable for use with a healing screw, a unique abatement member, and ultimately a permanent prosthesis or crown.

It is the object of the present invention to provide a method of implantation of the uniquely configured dental implant described herein which provides minimum trauma to the patient.

It is a further object of the present invention to provide a dental implantation method which utilizes minimal dental hardware and thus reduces the period of time for the implantation process and the expense of the process.

It is still another object of the present invention to provide a dental implant implantation method which materially reduces the healing time and ultimately the time before which a permanent crown or prosthesis can be secured.

These and other objects are accomplished by the present invention., a self-tapping dental implant which has a unitary body with an open end and a bottom tip end. The implant is tapered downward from the open top to the tip end and has an internal cavity extending for substantially the length of the implant. Smooth inner sidewalls are located at the upper end of the cavity and internal threads extend from the sidewalls down into the cavity.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective view of the dental implant of the present invention.

FIG. 2 is an elevation view of the dental implant of the present invention.

FIG. 3 is another elevation view of the dental implant of the present invention.

FIG. 4 is still another elevation view of the dental implant of the present invention.

FIG. 5 is another elevation view of the dental implant of the present invention.

FIG. 6 is a top view of the dental implant of the present invention.

FIG. 7 is a bottom view of the dental implant of the present invention.

FIG. 8 is a cross-sectional view of the dental implant of the present invention.

FIGS. 9-16 depict the method of installation of the dental implant and crown according to the present invention.

FIG. 17 is a view of a plurality of dental implants utilized to secure corresponding crowns in the mouth of a user.

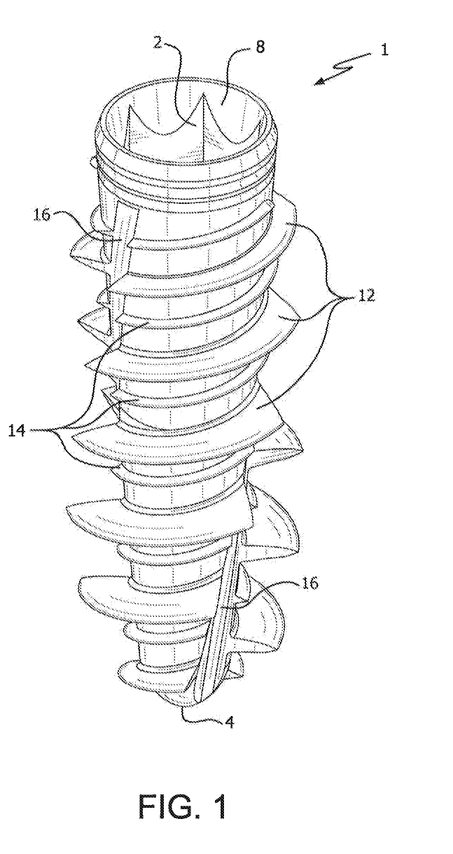

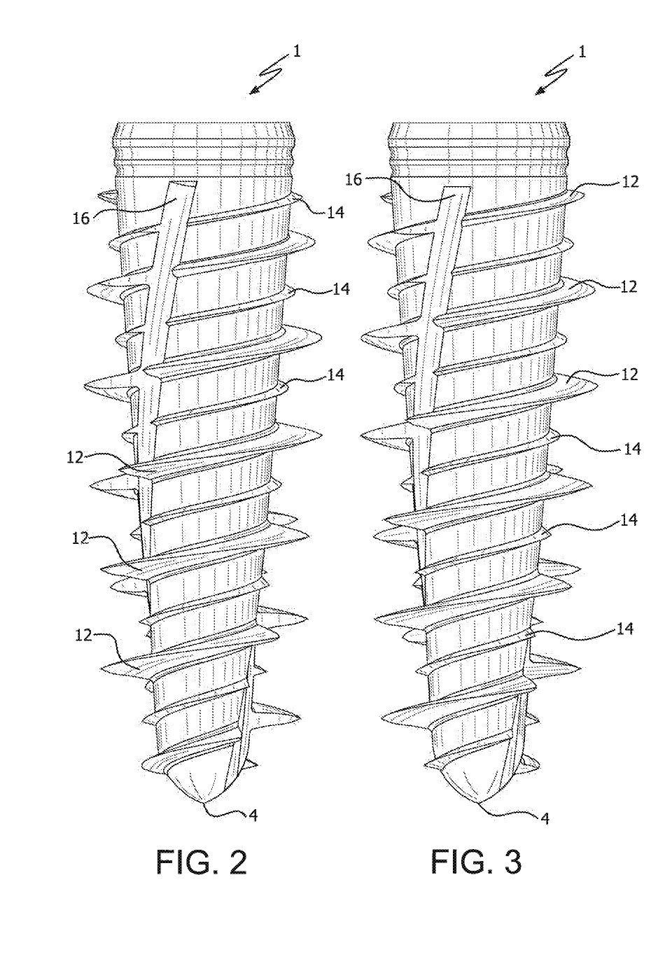

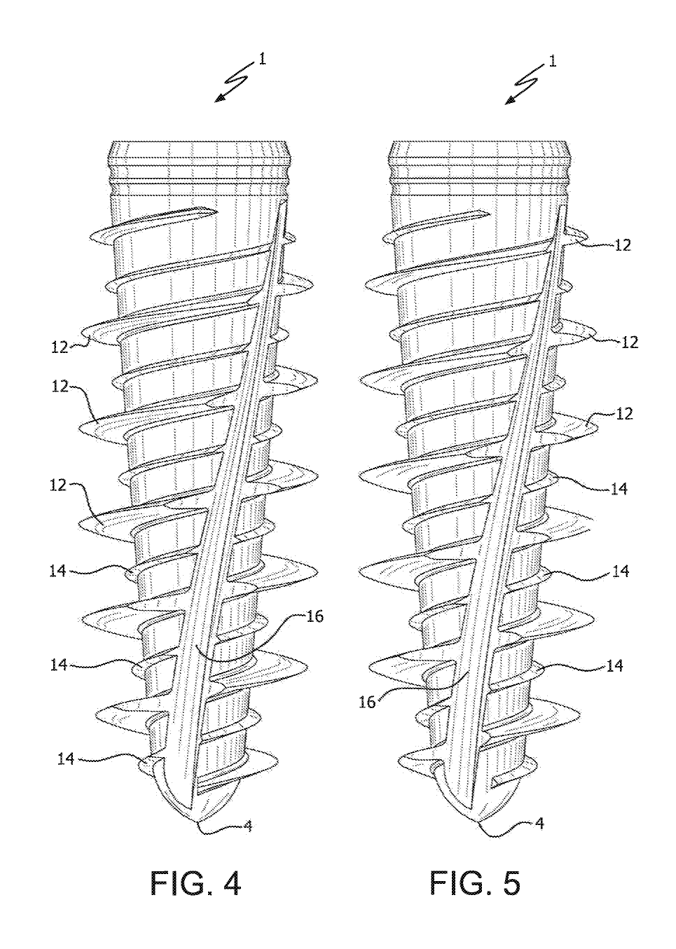

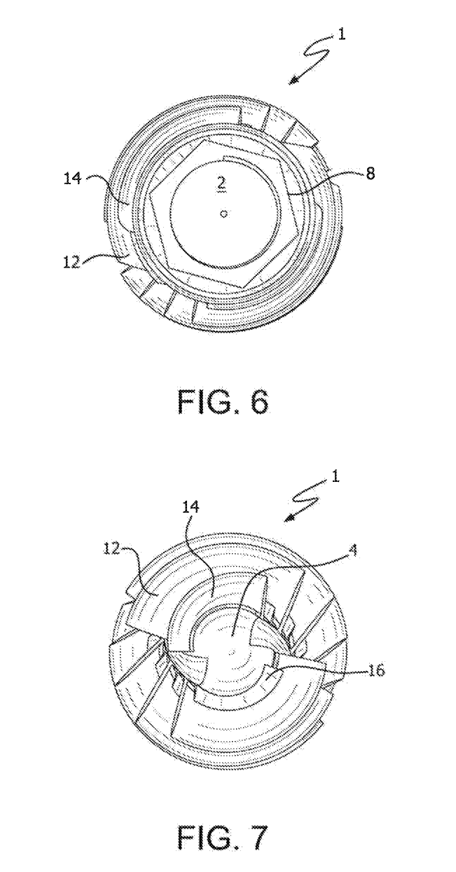

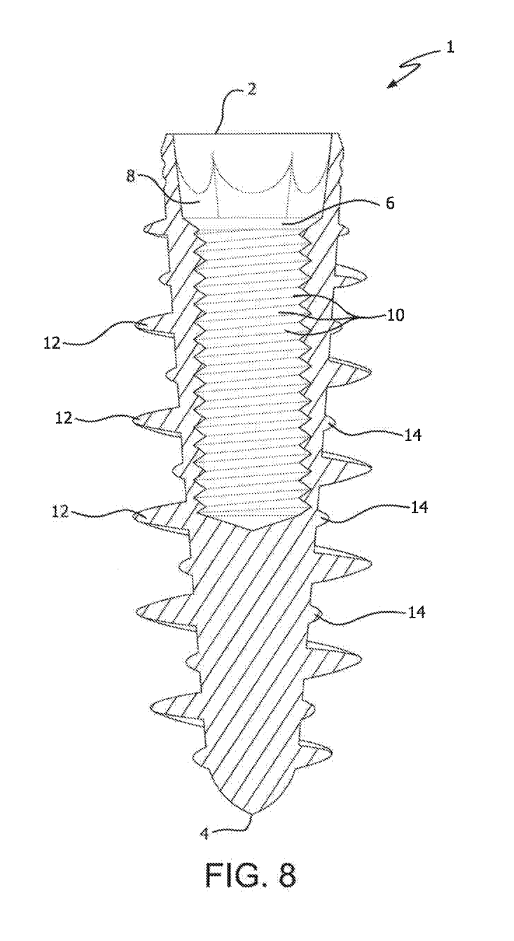

### DETAILED DESCRIPTION OF THE INVENTION

Self-tapping dental implant 1 is a unitary body having open top 2 and bottom tip end 4. Dental implant 1 is tapered downward from open top 2 to tip end 4. Internal cavity 6 extends from open top 2 down into dental implant 1. Smooth inner sidewalk 8 are located at the upper end of cavity 6 and internal threads 10 extend from the sidewalls down into the cavity.

Helical, wide pitch threads 12, having sharp, bladed edges extend along the exterior surface of implant 1. Smaller, helical, micro-threads 14, also with sharp blade edges, extend. along the exterior surface and are located between the helical threads 12. Channel 16 extends through all of the helical threads 12 and 14. Channel 16 runs obliquely, at an angle, from a location just below open top 2 to a location just above bottom tip end 4.

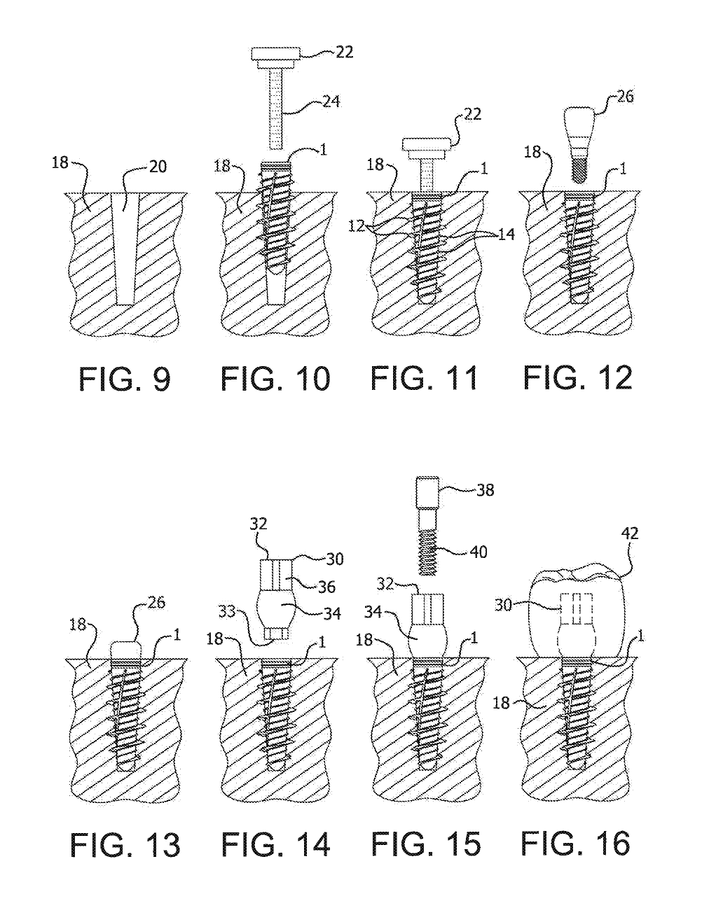

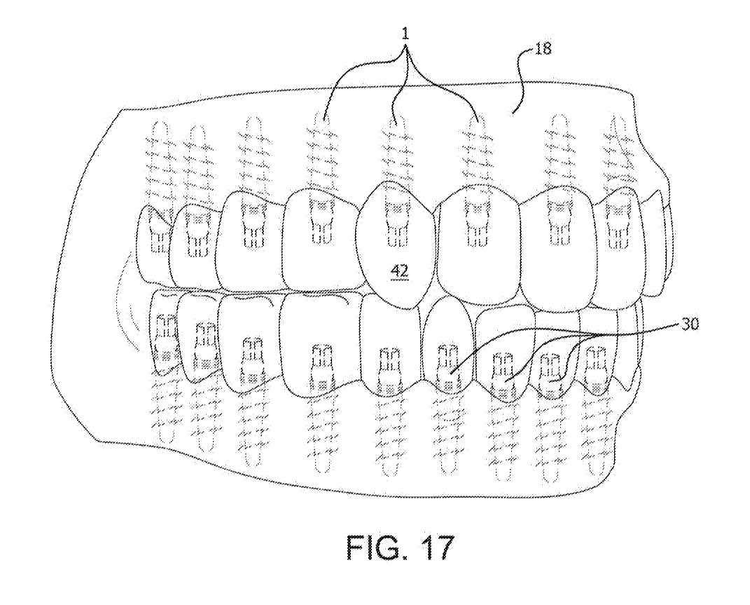

Dental implant 1 is used as follows to install a permanent implant/dental crown unit into either the maxilla or mandible bone 18 of a patient. A small hole 20 is bored or drilled into the bone of the patient. See FIG. 9. Dental implant 1 is inserted into hole 20. A standard dental tool. 22, having threads 24 which are configured to engage internal threads 10 of dental implant 1, is threadably mated with the internal threads and is then rotated in order to screw or tap dental implant 1 into hole 20 in bone 18 of the patient. See FIGS. 10 and 11. The wide pitch and deep depth of helical threads 12, with its sharp bladed edges, provide a high degree of initial stability to dental implant 1 in this process and also result in less trauma during the tapping of the dental implant into the bone. Micro-threads 14 in dental implant 1 maximizes the contact surface with the bone and provides additional support and stability during the tapping process.

In addition, as dental implant 1 is tapped down into bone 18 of the patient, loose bone material 40 is received and accumulates in channel 16. As this material travels up channel 16 as dental implant 1 is tapped down, it is expelled from the upper end of the channel. In this manner, the configuration and placement of channel 16 across helical threads 12 and 14 and its ability to expel loose cut bone material, makes the bone tapping operation go more quickly, with less impediments and, again, a less traumatic experience for the patient.

Rotation of dental tool 22 and resulting tapping of dental implant 1 continues until the top of the dental implant is substantially flush with the surface of bone 18. Dental tool 22 is then unthreaded and disengaged and removed from dental implant 1. See FIG. 11.

Healing screw 26, having threads 28 configured to engage internal threads 10 of dental implant 1, is threadably mated with the internal threads of the dental implant. See FIG. 12. Healing screw 26 is then rotated, engaging threads 28 and internal threads 10, resulting in the healing screw being inserted into cavity 6 of dental implant 1, until the healing screw is located just above the surface of bone 18 of the patient. See FIG. 13. In this location above the bone surface, the presence of healing screw 26 provides the patient with little, if any, significant impediment in his or her eating, speaking, etc.

Given the relatively minor trauma resulting from the insertion of the dental implant 1 and healing screw into bone 18 of the patient, a period of only approximately thirty (30) days is necessary for the gum and bone healing process. At that time, healing screw 26 is unscrewed so that the threads of the healing screw and the dental implant are disengaged. Healing screw 26 is then removed from dental implant 1.

Abatement member 30 has open top 32 and bottom 33 and is substantially hollow. It has bulbous mid-section 34 and platform support section 36. Bulbous mid-section 34 of abatement member 30 is configured to contact and be positioned within and on smooth sidewalls 8 at the upper end of cavity 6. See FIG. 15. This gives abatement member 30 a high degree of stability when it is connected to implant 1.

Attachment screw 38 comprises threaded section 40. See FIG. 15. After abatement member 30 is positioned within and on sidewalls 8 of implant 1, attachment screw 38 is lowered into open top 32 of and inserted through abatement member 30, such that at least threaded section 40 of the attachment extends out of open bottom 33 of the abatement member. Threaded section 40 of attachment screw 38 is then threadedly engaged with threads 10 within cavity 6 of implant 1, in order to lock abatement member 30 to the implant.

Crown 42 is positioned over abatement member 30 and permanently attached, such that the crown rests comfortably on the gum of the patient. See FIG. 16. The curved design of mid-section 34 and configuration of platform section 36 provide excellent support for the soft tissue and gum of the patient and prevents any shoulder contact with crown 42 mounted and secured onto abatement member 30.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A dental implant comprising a unitary body having a given length extending from an open top to a bottom tip end, said body being tapered from its open top where it is widest, to its bottom tip end, the body further comprising:
an internal cavity extending from the open top for the majority of the length of the body, the cavity having an upper end with smooth inner sidewalls and internal threads extending from the sidewalls down into the cavity;
first helical, wide pitch threads having sharp, blade edges, said threads being located along the exterior surface of the body and extending the length of the body from the top to the bottom tip end;
second helical, micro-threads having sharp, blade edges, said threads being located along and extending out from the exterior surface of the body, only one of the second threads being located between two contiguous first threads; and
a channel extending through all of the first and second threads without completely circumscribing the body, said channel running obliquely from a location below the open top to a location above the bottom tip end.

2. A method of implantation of a dental implant and crown in a patient comprising the steps of:
boring a hole into a predetermined site of the maxilla or mandible bone of the patient;
providing a self-tapping dental implant comprising exterior, helical threads, an internal cavity having an upper end with smooth inner sidewalls and internal threads extending from the sidewalls down into the cavity, and a channel extending through the external helical threads;
inserting the dental implant into the bored hole in the bone;
providing a dental tool with threads which are configured to engage the internal threads of the dental implant;
threadably engaging the internal threads in the cavity of the dental tool with the internal threads of the dental implant;
rotating the dental tool while its threads are engaged with the internal threads of the dental implant;
rotating the dental tool with its threads engaged with the internal threads of the dental implant, thereby tapping the dental implant into the hole in the bone of the patient;
continuing the rotation of the dental tool until the top of the dental implant is flush with the surface of the bone;
receiving and accumulating loose bone material in the channel as the dental implant is being tapped down into the bone;
expelling loose bone material from the channel as the dental implant is being tapped down into the bone;
providing a healing screw with threads which are configured to engage the internal threads in the cavity of the dental implant;
threadably engaging the threads of the healing screw with the internal threads of the dental implant;
rotating the healing screw while its threads are engaged with the dental implant, thereby screwing the healing screw into the dental implant;
continuing the rotation of the healing screw with its threads engaged with the dental implant until the top section of the healing screw is above the surface of the bone;
rotating the healing screw out of the implant, thereby disengaging the threads of the healing screw and the dental implant;
removing the healing screw from the dental implant solely by rotating the healing screw out of the implant and disengaging the threads of the healing screw and the implant, thereby maintaining the top of the implant flush with the surface of the bone;
providing an abatement member;
positioning the abatement member on and within the inner sidewalls of the dental implant;
securing the abatement member to the dental implant to lock the abatement member to the dental implant;
providing a crown member; and
positioning and securing the crown member onto the abatement member.

3. The method as in claim 2 wherein the healing screw is removed from the dental implant approximately one month after it is screwed into the implant.

4. The method as in claim 3 wherein the abatement member is positioned on and within the inner sidewalls of the dental implant immediately after the healing screw is removed from the dental implant.

5. The method as in claim 3 wherein securing the abatement member comprises the steps of:
providing an attachment screw with a threaded section;
inserting the attachment screw through the abatement member, such that the threaded section of the attachment screw extends out of the abatement member;
threadably engaging the threads of the attachment screw with the internal threads of the dental implant; and
rotating the attachment screw while its threads are engaged with the internal threads of the dental implant, thereby locking the abatement member into the dental implant.
